(19) United States
(12) Patent Application Publication
(10) Pub. No.: US 2026/0239084 A1
(43) Pub. Date: Aug. 13, 2026

(54) METHOD AND APPARATUS FOR COMPUTATION OF COMMUNICATION QUANTITIES FOR DEVICE IN PROXIMITY AREA NETWORK IN MOBILE COMMUNICATIONS

(71) Applicant: MEDIATEK INC., Hsinchu City (TW)

(72) Inventors: Lung-Sheng TSAI, Hsinchu City (TW); Pei-Kai LIAO, Hsinchu City (TW)

(73) Assignee: MEDIATEK INC., Hsinchu City (TW)

(21) Appl. No.: 19/472,767

(22) PCT Filed: Aug. 8, 2024
(86) PCT No.: PCT/CN2024/110564

§ 371 Date: Oct. 6, 2025

Related U.S. Application Data
(60) Provisional application No. 63/518,114, filed on Aug. 8, 2023.

(51) Int. Cl. H04W 24/10

(52) U.S. Cl. CPC H04W 24/10

(57) ABSTRACT

Examples pertaining to distributed computing of devices in a proximity area network are described. A first device may generate a measurement association with a second device proximal thereto and generate a measurement report of the first device and a derived measurement report of the second device after performing a measurement for a communication quantity with respect to a network node. The first device may be capable of jointly transmitting the measurement report and the derived measurement report to the network node or transmitting the derived measurement report to the second device.

### CROSS REFERENCE TO RELATED PATENT APPLICATION(S)

The present disclosure is part of a non-provisional application claiming the priority benefit of U.S. Patent Application No. 63/518,114, filed on 8 Aug. 2023, the content of which herein being incorporated by reference in its entirety.

### TECHNICAL FIELD

The present disclosure is generally related to mobile communications and, more particularly, to distributed computing of devices in a proximity area network in mobile communications.

### BACKGROUND

Unless otherwise indicated herein, approaches described in this section are not prior art to the claims listed below and are not admitted as prior art by inclusion in this section.

As 5^{th} Generation (5G) technology continues to mature and expand, the New Radio (NR) network can support a wider range of applications for mobile communication devices, such as mobile phones and associated peripheral smart devices. In daily life, users might simultaneously carry a mobile phone and a smartwatch (and/or other peripheral smart devices). Each of these devices may have an independent communication function for connecting to the NR network and may camp on the same base station which is usually called a gNB (or gNodeB). In this case, these devices are likely to experience similar communication quality due to their proximity.

However, each of them still needs to perform an independent measurement for a communication quantity with respect to the gNB to determine the communication quantities for both transmitting signals to the gNB and receiving signals from it. These processes consume the power of all the devices and also waste the resources of the gNB.

Furthermore, peripheral smart devices, such as smartwatches, smart glasses, typically have smaller battery capacities. The batteries of these devices will run out of power if they are required to frequently perform measurements for the communication quantity with respect to the gNB due to their mobility.

Accordingly, the industry is striving to provide a communication mechanism for mobile communication devices in a proximity area network to determine the communication quantities with respect to the gNB in an effective way to solve some or all of the above problems.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that provide a communication mechanism for mobile communication devices in a proximity area network to effectively determine the communication quantities with respect to the base station, thereby reducing power consumption and device overhead, especially for peripheral smart devices, and improving the signal transmission performance of the mobile network (e.g., the NR network).

In one aspect, a method may involve an apparatus generating a measurement association with a user equipment (UE) for a communication quantity. The method may also involve the apparatus performing a measurement for the communication quantity with respect to a network node. The method may further involve the apparatus generating a derived measurement report of the UE according to the measurement and the measurement association.

In one aspect, a method may involve an apparatus confirming a measurement association between a first UE and a second UE for a communication quantity. The method may also involve the apparatus transmitting a configuration message to the first UE for the first UE to perform a measurement for the communication quantity after confirming the measurement association. The method may further involve the apparatus receiving a measurement report message including a measurement report of the first UE and a derived measurement report of the second UE. The measurement report and the derived measurement report may be generated by the first UE according to the measurement.

In one aspect, a method may involve an apparatus generating a measurement association with a UE for a communication quantity. The method may also involve the apparatus receiving, by the processor, a derived measurement report from the UE. The derived measurement report may be generated by the UE after performing a measurement for the communication quantity with respect to a network node. The method may further involve the apparatus transmitting a measurement report message according to the derived measurement report to the network node.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIGS. 1A-1C are diagrams depicting example scenarios under schemes in accordance with implementations of the present disclosure.

FIG. 2 is a block diagram of an example communication system in accordance with an implementation of the present disclosure.

FIG. 3 is a flowchart of an example process in accordance with an implementation of the

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to distributed computing of devices in a proximity area network for a mobile communication network. According to the present disclosure, a number of possible solutions may be implemented separately or jointly. That is, although these possible solutions may be described below separately, two or more of these possible solutions may be implemented in one combination or another.

The communication mechanism of the present disclosure is applicable to a mobile communication network (e.g., an LTE network, a 5G/NR network, an IoT network or a 6G network). In this mobile communication network, a first UE and a second UE may camp on the same network node which provides a wide area coverage for long-range communication. The first UE may typically have higher capability and/or battery capacity than the second UE, such that the first UE may be suitable for performing heavy computation for a communication quantity.

In addition, the first UE and the second UE may be located in close proximity to each other and may establish a short-range wireless connection with each other to perform a short-range communication. The first UE may generate (i.e., may build) a measurement association with the second UE through the short-range wireless connection. The first UE may perform a measurement for a communication quantity with respect to a network node. The first UE generates a measurement report for itself and a derived measurement report for the second UE according to the measurement. The first UE may jointly transmit the measurement report and the derived measurement report to the network node. Alternatively, the first UE may only transmit the measurement report to the network node and transmit the derived measurement report to the second UE so that the second UE may transmit a measurement report to the network node according to the derived measurement report.

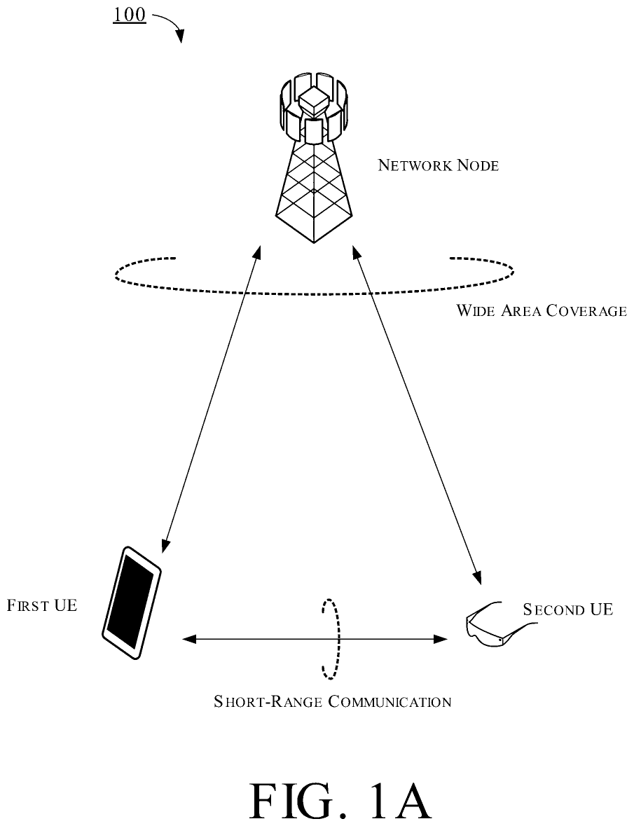

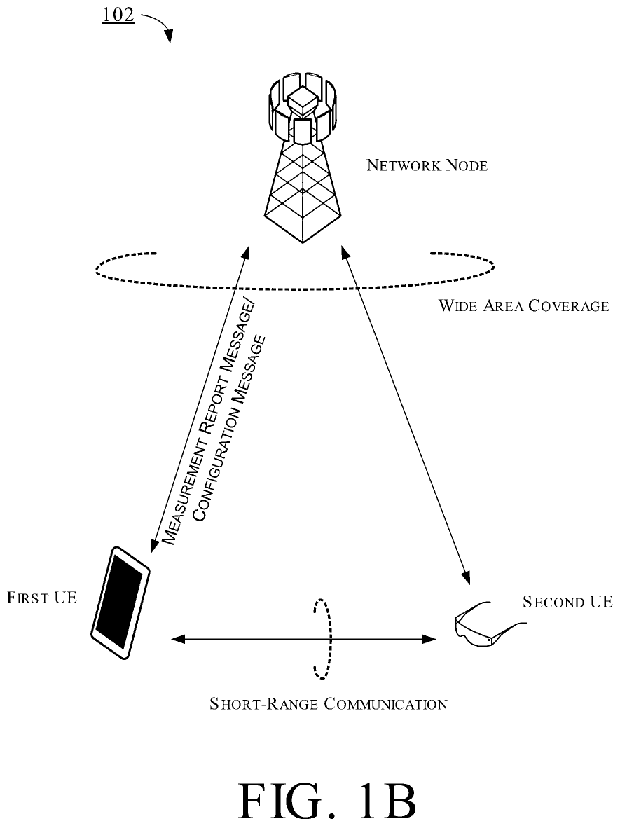

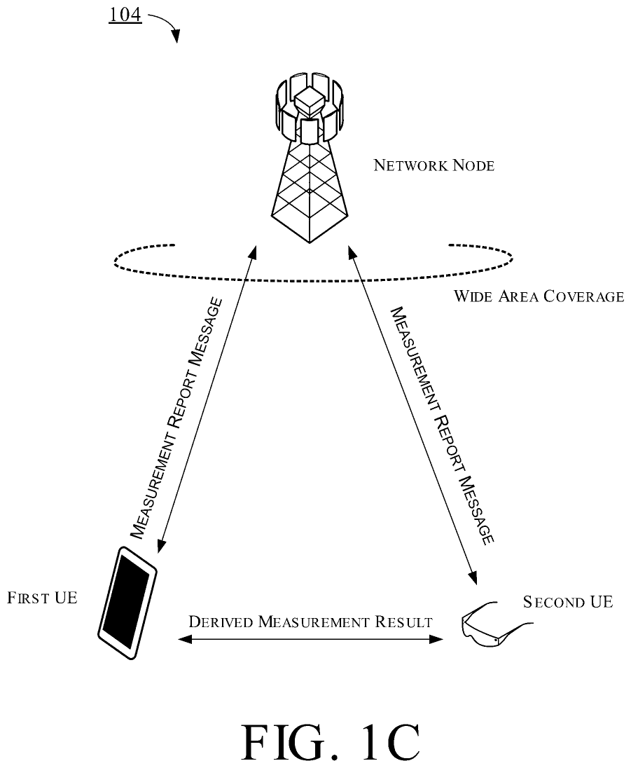

FIGS. 1A to 1C illustrate example scenarios 100, 102 and 104 under schemes in accordance with implementations of the present disclosure. Scenarios 100, 102 and 104 involve a mobile communication network (e.g., an NR network) including a network node (e.g., a gNB of the NR network), a first UE (e.g., a mobile phone) and a second UE (e.g., a smart glass). In the network framework of scenarios 100, 102 and 104, the first UE and the second UE may camp on the network node for long-range communication. The first UE and the second UE may directly connect to each other to perform a short-range communication. For example, the first UE and the second UE may establish a Bluetooth connection, a Wi-Fi connection or any other short-range wireless connection to exchange their information.

Since the first UE and the second UE may be located in close proximity to each other, they may have similar communication quantities with respect to the network apparatus. As a result, the first UE may generate (i.e., build) a measurement association with the second UE through the short-range wireless connection. Based on the measurement association, the first UE may act as a collaborative UE to perform heavy computation for a communication quantity with respect to the network node. Then, the first UE may perform a measurement for a communication quantity with respect to the network node and generate a measurement report of the first UE and a derived measurement report of the second UE according to the measurement and the measurement association. As a result, the power consumption and device overhead of the second UE may be significantly reduced.

In some embodiments, as shown in FIG. 1B, the first UE may jointly transmit the measurement report and the derived measurement report to the network apparatus. In some cases, the network node may allocate a signal uplink container, i.e., the uplink resource such as PUCCH (Physical Uplink Control Channel) and/or PUSCH (Physical Uplink Shared Channel), for the first UE to transmit a measurement report message including the measurement report and the derived measurement report. In these cases, the first UE may receive a configuration message from the network node, which indicates at least one of a reference signal for the measurement for the communication quantity and an uplink resource allocated for transmitting the measurement report message. In virtue of this joint transmission of measurement reports of the first UE and the second UE, the network node may not be required to configure a reference signal and an uplink resource for the second UE to perform a measurement for the communication quantity, thereby improving the signal transmission performance of the mobile communication network.

In some embodiments, as shown in FIG. 1C, the first UE may transmit the measurement report of itself to the to the network node and transmit the derived measurement report to the second UE. After receiving the derived measurement report, the second UE may refine the derived measurement report to generate a refined measurement report based on, for example, the signal transmission status between the second UE and the network node. The network node may allocate two uplink containers for the first UE to transmit a measurement report message including the measurement report and for the second UE to transmit another measurement report message including the derived measurement report or the refined measurement result, respectively.

In some implementations, the generation of the measurement association may be trigged by UE side. For example, the first UE may receive a plurality of measurement reports for the communication quantity from the second UE. The measurement reports may be generated by the second UE from the most recent measurements for the communication quantity with respect to the network apparatus. Next, the first UE may determine whether a similarity of the communication quantity between itself and the second UE holds (e.g., a difference of the communication quantity between the first UE and the second UE is less than a threshold) or whether it is capable of generating the derived measurement report of the UE according to the measurement performed for itself. If the similarity holds or the first UE is capable of generating the derived measurement report, the first UE may confirm the measurement association. The first UE may transmit an association confirmation message to the network node to inform the network node of the measurement association between the first UE and the second UE. For example, the association confirmation message may indicate that the first UE is capable of generating the derived measurement report of the second UE.

In some implementations, the generation of the measurement association may be trigged by network side. For example, the network node may receive a plurality of first measurement report messages from the first UE and a plurality of second measurement report messages from the second UE. The first measurement report messages may be generated by the first UE based on the most recent measurements for the communication quantity with respect to the network node, and the second measurement report messages may be generated by the second UE based on the most recent measurements for the communication quantity with respect to the network node.

The network apparatus may determine whether a similarity of the communication quantity between the first UE and the second UE is greater than a threshold based on the first measurement report messages generated by the first UE and the second measurement report messages generated by the second UE. The network apparatus may confirm the measurement association if the similarity of the communication quantity between the first UE and the second UE is greater than the threshold and transmit an association confirmation message to the first UE and/or the second UE for the measurement association between the first UE and the second UE for the communication quantity. After receiving the association confirmation message from the network node, the first UE and the second UE may generate the measurement association. In some cases, the first UE and/or the second UE may transmit acknowledgements to the network node after the measurement association is generated.

In some implementations, the network node may generate the association confirmation message by confirming that a similarity of the communication quantity between the first UE and the second UE holds (e.g., determining the similarity of the communication quantity between the first UE and the second UE is greater than a threshold or the difference of the communication quantity between the first UE and the second UE is less than a difference threshold) or that the first UE is capable of generating the derived measurement report according to the measurement (e.g., based on a capability report generated by the first UE).

In some implementations, the termination of the measurement association may be triggered by UE side. For example, the first UE may terminate the measurement association with the second UE when the short-range wireless connection with the second UE is interrupted. Once the measurement association is terminated, the first UE may transmit a termination message for terminating the measurement association to the network node to inform the network node of the termination of the measurement association between the first UE and the second UE. In another example, the second UE may terminate the measurement association with the first UE when the short-range wireless connection with the first UE is interrupted and transmit an termination message for terminating the measurement association to the network node to inform the network apparatus of the termination of the measurement association between the first UE and the second UE.

In some implementations, the termination of the measurement association may be triggered by network side. For example, the network node may terminate the measurement association between the first UE and the second UE if the network node is aware that one of the first UE and the second UE is disconnected from the network node or the data transmitted from the second UE cannot be correctly received for several consecutive times. Next, the network node may transmit a termination message to the first UE and/or the second UE to instruct the first UE and/or the second UE to terminate the measurement association therebetween.

In some embodiments, the communication quantity is for one of the following purposes: channel state information (CSI) computation, beam management (BM) report calculation, UE Receiver (Rx)/Transmitter (Tx) beam sweeping, radio resource management (RRM) measurement, and measurement for mobility.

For example, the CSI computation may involve precoding matrix information (PMI) or some wideband quantities, and the measurement for mobility may involve reference signal received power (RSRP).

In some implementations, if the derived measurement report includes the metric of the RRM measurement, the network node may not be required to configure the RRM gap for the second UE to perform an RRM measurement, and the second UE may not be required to perform such an RRM measurement. Therefore, the data transmission between the network apparatus and the second UE may not be interrupted by the RRM gap.

In some embodiments, the first UE may generate (i.e., build) a computation model (e.g., artificial intelligence (AI) model, machine learning (ML) model, an algorithm model, etc.) based on a plurality of actual measurement differences between the first UE and the second UE. The first UE may input a plurality of actual measurement results into the computation model to generate the derived measurement result. For example, the first UE may utilize a machine learning/deep learning technique to train a model by inputting a plurality of pairs of actual measurement results generated by the first UE and the second UE as the training data and use the trained model as the computation model. Therefore, the first UE may input the measurement into the computation model to generate the derived measurement report. In other embodiments, the first UE may generate the derived measurement report by a mapping table that records the actual measurement differences between the first UE and the second UE, e.g., the mapping table records that the RSRP difference between the first UE and the second UE is 2 decibels (dB).

In some embodiments, the first UE and the second UE may both be mobile phones in the same space, e.g., two mobile phones in the same car. In these embodiments, the first UE and the second UE may have the same capability or different capabilities, and/or have the same battery capacity or different battery capacities.

In some embodiments, the first UE and the second UE may both be peripheral smart devices, e.g., the first UE is a smartwatch, and the second UE is a smart glass. Similarly, in this case, the first UE and the second UE may have the same capability or different capabilities, and/or have the same battery capacity or different battery capacities.

In some embodiments, in addition to the second UE, the first UE may further generate other derived measurement report(s) for other UE(s) proximal to it according to measurement for the communication quantity and may jointly report the measurement report and these derived measurement reports to the network apparatus. Therefore, any variation in the number of the derived measurement reports generated by the first UE for the proximal UEs shall be applicable to the present invention.

### Illustrative Implementations

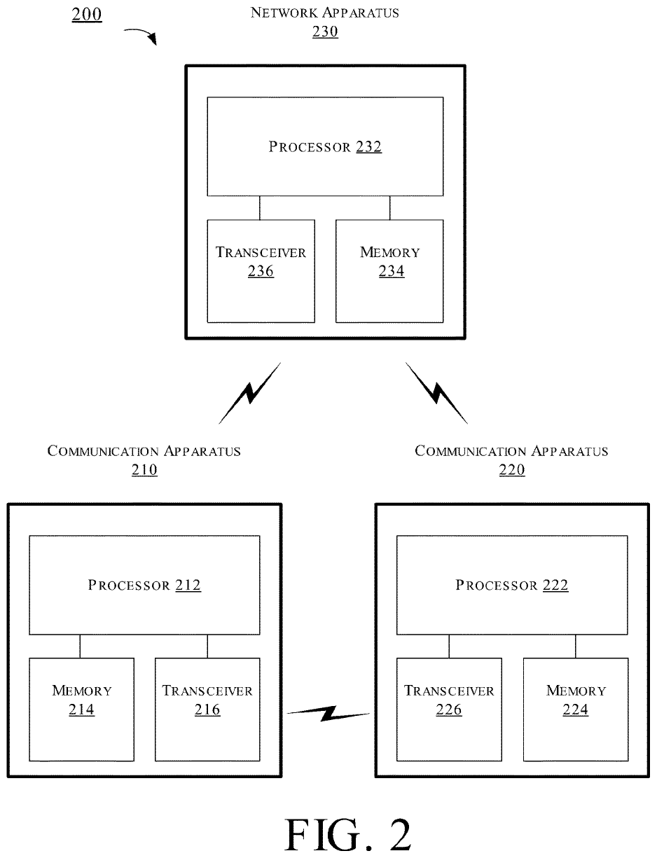

FIG. 2 illustrates an example communication system 200 having an example communication apparatus 210, an example communication apparatus 220, and an example network apparatus 230 in accordance with an implementation of the present disclosure. Each of communication apparatus 210, communication apparatus 220 and network apparatus 230 may perform various functions to implement schemes, techniques, processes and methods described herein pertaining to distributed computing of devices in a proximity area network in mobile communications, including scenarios/schemes described above as well as process 300, process 400 and process 500 described below.

Communication apparatus 210/220 may be a part of an electronic apparatus, which may be a UE such as a portable or mobile apparatus, a wearable apparatus, a mobile communication apparatus or a computing apparatus. For instance, communication apparatus 210/220 may be implemented in a smartphone, a smartwatch, a personal digital assistant, a digital camera, or a computing equipment such as a tablet computer, a laptop computer or a notebook computer. Communication apparatus 210/220 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 210/220 may be implemented in a smart thermostat, a smart fridge, a smart door lock, a wireless speaker or a home control center. Alternatively, communication apparatus 210/220 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210/220 may include at least some of those components shown in FIG. 2 such as a processor 212/222, for example. Communication apparatus 210/220 may further include one or more other components not pertinent to the proposed scheme of the present disclosure (e.g., internal power supply, display device and/or user interface device), and, thus, such component(s) of communication apparatus 210/220 are neither shown in FIG. 2 nor described below in the interest of simplicity and brevity.

Network apparatus 230 may be a part of a network device, which may be a network node such as a satellite, a base station, a small cell, a router or a gateway. For instance, network apparatus 230 may be implemented in an eNodeB in an LTE network, in a gNB in a 5G/NR, IoT, NB-IoT or IIoT network or in a satellite or base station in a 6G network. Alternatively, network apparatus 230 may be implemented in the form of one or more IC chips such as, for example and without limitation, one or more single-core processors, one or more multi-core processors, or one or more RISC or CISC processors. Network apparatus 230 may include at least some of those components shown in FIG. 2 such as a processor 232, for example. Network apparatus 230 may further include one or more other components not pertinent to the proposed scheme of the present disclosure (e.g., internal power supply, display device and/or user interface device), and, thus, such component(s) of network apparatus 230 are neither shown in FIG. 2 nor described below in the interest of simplicity and brevity.

In one aspect, each of processor 212, process 222 and processor 232 may be implemented in the form of one or more single-core processors, one or more multi-core processors, or one or more CISC processors. That is, even though a singular term “a processor” is used herein to refer to processor 212, processor 222 and processor 232, each of processor 212, processor 222 and processor 232 may include multiple processors in some implementations and a single processor in other implementations in accordance with the present disclosure. In another aspect, each of processor 212, processor 222 and processor 232 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212, processor 222 and processor 232 is a special-purpose machine specifically designed, arranged and configured to perform specific tasks including autonomous reliability enhancements in a device (e.g., as represented by communication apparatus 210 and communication apparatus 220) and a network (e.g., as represented by network apparatus 230) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, communication apparatus 220 may also include a transceiver 226 coupled to processor 222 and capable of wirelessly transmitting and receiving data. In some implementations, communication apparatus 220 may further include a memory 224 coupled to processor 222 and capable of being accessed by processor 222 and storing data therein. In some implementations, network apparatus 230 may also include a transceiver 236 coupled to processor 232 and capable of wirelessly transmitting and receiving data. In some implementations, network apparatus 230 may further include a memory 234 coupled to processor 232 and capable of being accessed by processor 232 and storing data therein. Accordingly, communication apparatus 210, communication apparatus 220 and network apparatus 420 may wirelessly communicate with each other via transceiver 216, transceiver 226 and transceiver 236, respectively.

In some implementations, communication apparatus 210/220 may further include a memory 214/224 coupled to processor 212/222 and capable of being accessed by processor 212/222 and storing data therein. In some implementations, network apparatus 230 may further include a memory 234 coupled to processor 232 and capable of being accessed by processor 232 and storing data therein. Each of memory 214/224 and memory 234 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214/224 and memory 234 may include a type of read-only memory (ROM) such as mask ROM, programmable ROM (PROM), erasable programmable ROM (EPROM) and/or electrically erasable programmable ROM (EEPROM). Alternatively, or additionally, each of memory 214/224 and memory 234 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 210/220 and network apparatus 230 may be a communication entity capable of communicating with each other using various proposed schemes in accordance with the present disclosure. For illustrative purposes and without limitation, descriptions of capabilities of communication apparatus 210/220, as a UE, and network apparatus 230, as a network node (e.g., gNB), are provided below with processes 300, 400 and 500.

### Illustrative Processes

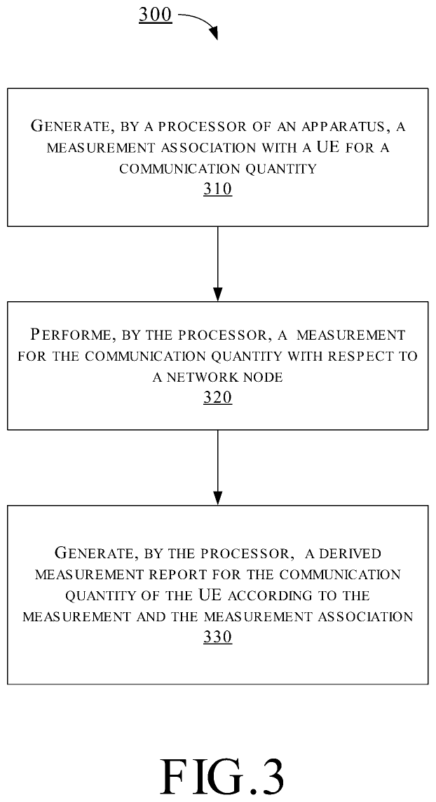

FIG. 3 illustrates an example process 300 in accordance with an implementation of the present disclosure. Process 300 may be an example implementation of above scenarios/schemes, whether partially or completely, with respect to distributed computing of devices in a proximity area network in mobile communications of the present disclosure. Process 300 may represent an aspect of implementation of features of communication apparatus 210. Process 300 may include one or more operations, actions, or functions as illustrated by one or more of blocks 310 to 330. Although illustrated as discrete blocks, various blocks of process 300 may be divided into additional blocks, combined into fewer blocks, or eliminated, depending on the desired implementation. Moreover, the blocks of process 300 may be executed in the order shown in FIG. 3 or, alternatively, in a different order. Process 300 may be implemented by communication apparatus 210 or any suitable communication device or machine type devices. Solely for illustrative purposes and without limitation, process 300 is described below in the context of the communication apparatus 210. Process 300 may begin at block 310.

At block 310, process 300 may involve processor 212 of communication apparatus 210 generating a measurement association with a UE for a communication quantity. Process 300 may proceed from block 310 to block 320.

At block 320, process 300 may involve processor 212 performing a measurement for communication quantity with respect to a network node. Process 300 may proceed from block 320 to block 330.

At block 330, process 300 may involve processor 212 generating a derived measurement report for the communication quantity of the UE according to the measurement and the measurement association.

In some implementations, process 300 may further involve processor 212 transmitting the derived measurement report to the UE or to the network node.

In some implementations, process 300 may further involve generating a measurement report for the communication quantity of communication apparatus 210 according to the measurement, and transmitting a measurement report message including the measurement report and the derived measurement report to the network node.

In some implementations, process 300 may further involve processor 212 receiving a configuration message from the network node. The configuration message may indicate at least one of a reference signal for the measurement and an uplink resource allocated for transmitting the measurement report message.

In some implementations, for generating the measurement association with the UE, process 300 may further involve processor 212 determining whether a similarity of the communication quantity between communication apparatus 210 holds or whether communication apparatus 210 is capable of generating the derived measurement report of the UE according to the measurement, confirming the measurement association in an event that the similarity of the communication quantity between communication apparatus 210 and the UE holds or communication apparatus 210 is capable of generating the derived measurement report according to the measurement, and transmitting an association confirmation message to the network node after confirming the measurement association.

In some implementations, whether the similarity of the communication quantity between communication apparatus 210 and the UE holds may be determined by whether a difference of the communication quantity between communication apparatus 210 and the UE is less than a threshold.

In some implementations, for generating the measurement association with the UE, process 300 may further involve processor 212 receiving an association confirmation message from the network node. The association confirmation message may be generated by the network node after the network node confirms that a similarity of the communication quantity between communication apparatus 210 and the UE holds or that communication apparatus 210 is capable of generating the derived measurement report according to the measurement.

In some implementations, process 300 may further involve processor 212 terminating the measurement association with the UE, and transmitting a termination message for terminating the measurement association to the network node.

In some implementations, process 300 may further involve processor 212 receiving a termination message from the network node, and terminating the measurement association with the UE according to the association termination message.

In some implementations, the communication quantity may be for one of the following purposes: CSI computation, BM report calculation, UE Rx/Tx beam sweeping, RRM measurement, and mobility measurement.

In some implementations, process 300 may further involve processor 212 generating a computation model based on a plurality of actual measurement differences between communication apparatus 210 and the UE. The derived measurement report may be generated by inputting the measurement into the computation model.

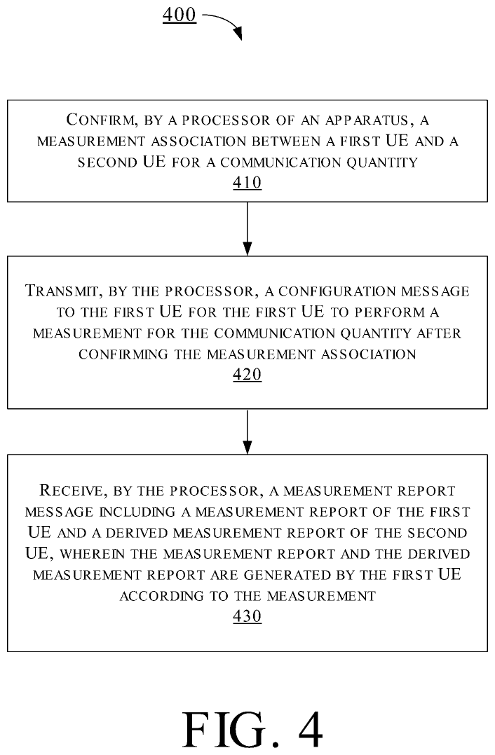

FIG. 4 illustrates an example process 400 in accordance with an implementation of the present disclosure. Process 400 may be an example implementation of above scenarios/schemes, whether partially or completely, with respect to distributed computing of devices in a proximity area network in mobile communications of the present disclosure. Process 400 may represent an aspect of implementation of features of network apparatus 230. Process 400 may include one or more operations, actions, or functions as illustrated by one or more of blocks 410 to 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by network apparatus 230 or any suitable network device or machine type devices. Solely for illustrative purposes and without limitation, process 400 is described below in the context of the network apparatus 230. Process 400 may begin at block 410.

At block 410, process 400 may involve processor 232 of network apparatus 230 confirming a measurement association between a first UE and a second UE for a communication quantity. Process 400 may proceed from block 410 to block 420.

At block 420, process 400 may involve processor 232 transmitting a configuration message to the first UE for the first UE to perform a measurement for the communication quantity after confirming the measurement association. Process 400 may proceed from block 420 to block 430.

At block 430, process 400 may involve processor 232 receiving a measurement report message including a measurement report of the first UE and a derived measurement report of the second UE. The measurement report and the derived measurement report may be generated by the first UE according to the measurement.

In some implementations, the configuration message may indicate a reference signal for the measurement and an uplink resource allocated for transmitting the measurement report message.

In some implementations, for confirming the measurement association, process 400 may further involve processor 232 receiving an association confirmation message from the first UE. The association confirmation message mat indicate that the first UE is capable of generating the derived measurement report of the second UE.

In some implementations, for confirming the measurement association, process 400 may further involve processor 232 determining whether a similarity of the communication quantity between the first UE and the second UE is greater than a threshold based on a plurality of first measurement report messages generated by the first UE and a plurality of second measurement report messages generated by the second UE, confirming the measurement association in an event that the similarity is greater than the threshold, and transmitting an association confirmation message to the first UE or the second UE for the measurement association between the first UE and the second UE for the communication quantity.

In some implementations, process 400 may further involve processor 232 receiving a termination message from the first UE indicating that the first UE terminates the measurement association with the second UE.

In some implementations, process 400 may further involve processor 232 transmitting a termination message to the first UE so that the first UE terminates the measurement association with the second UE according to the association termination message.

In some implementations, the communication quantity may be for one of the following purposes: CSI computation, BM report calculation, UE Rx/Tx beam sweeping, RRM measurement, and mobility measurement.

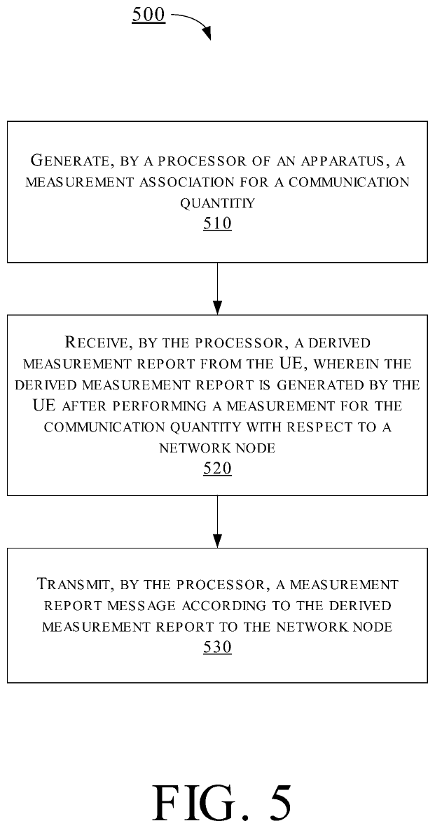

FIG. 5 illustrates an example process 500 in accordance with an implementation of the present disclosure. Process 500 may be an example implementation of above scenarios/schemes, whether partially or completely, with respect to distributed computing of devices in a proximity area network in mobile communications of the present disclosure. Process 500 may represent an aspect of implementation of features of communication apparatus 220. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 220 or any suitable communication device or machine type devices. Solely for illustrative purposes and without limitation, process 500 is described below in the context of the communication apparatus 220. Process 500 may begin at block 510.

At block 510, process 500 may involve processor 222 of communication apparatus 220 generating a measurement association with a UE for a communication quantity. Process 500 may proceed from block 510 to block 520.

At block 520, process 500 may involve processor 222 receiving a derived measurement report from the UE. The derived measurement report may be generated by the UE after performing a measurement for the communication quantity with respect to a network node. Process 500 may proceed from block 520 to block 530.

At block 530, process 500 may involve processor 222 transmitting a measurement report message according to the derived measurement report to the network node.

In some implementations, the measurement report message may include the derived measurement report or a refined measurement report. The refined measurement report may be generated according to the derived measurement report.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a measurement association with a user equipment (UE) for a communication quantity;
performing, by the processor, a measurement for the communication quantity with respect to a network node; and
generating, by the processor, a derived measurement report for the communication quantity of the UE according to the measurement and the measurement association.

2. The method of claim 1, further comprising:
transmitting, by the processor, the derived measurement report to the UE or to the network node.

3. The method of claim 1, further comprising:
generating, by the processor, a measurement report for the communication quantity of the apparatus according to the measurement; and
transmitting, by the processor, a measurement report message including the measurement report and the derived measurement report to the network node.

4. The method of claim 3, further comprising:
receiving, by the processor, a configuration message from the network node, wherein the configuration message indicates at least one of a reference signal for the measurement and an uplink resource allocated for transmitting the measurement report message.

5. The method of claim 1, wherein the generating of the measurement association with the UE further comprises:
determining, by the processor, whether a similarity of the communication quantity between the apparatus and the UE holds or whether the apparatus is capable of generating the derived measurement report of the UE according to the measurement;
confirming, by the processor, the measurement association in an event that the similarity of the communication quantity between the apparatus and the UE holds or the apparatus is capable of generating the derived measurement report according to the measurement; and
transmitting, by the processor, an association confirmation message to the network node after confirming the measurement association.

6. The method of claim 5, wherein whether the similarity of the communication quantity between the apparatus and the UE holds is determined by whether a difference of the communication quantity between the apparatus and the UE is less than a threshold.

7. The method of claim 1, wherein the generating of the measurement association with the UE further comprises:
receiving, by the processor, an association confirmation message from the network node, wherein the association confirmation message is generated by the network node after the network node confirms that a similarity of the communication quantity between the apparatus and the UE holds or that the apparatus is capable of generating the derived measurement report according to the measurement.

8. The method of claim 1, further comprising:
terminating, by the processor, the measurement association with the UE; and
transmitting, by the processor, a termination message for terminating the measurement association to the network node.

9. The method of claim 1, further comprising:
receiving, by the processor, a termination message from the network node; and
terminating, by the processor, the measurement association with the UE according to the association termination message.

10. The method of claim 1, wherein the communication quantity is for one of the following purposes: channel state information (CSI) computation, beam management (BM) report calculation, UE Receiver (Rx)/Transmitter (Tx) beam sweeping, radio resource management (RRM) measurement, and mobility measurement.

11. The method of claim 1, further comprising:
generating, by the processor, a computation model based on a plurality of actual measurement differences between the apparatus and the UE, wherein the derived measurement report is generated by inputting the measurement into the computation model.

12. A method, comprising:
confirming, by a processor of an apparatus, a measurement association between a first UE and a second UE for a communication quantity;
transmitting, by the processor, a configuration message to the first UE for the first UE to perform a measurement for the communication quantity after confirming the measurement association; and
receiving, by the processor, a measurement report message including a measurement report of the first UE and a derived measurement report of the second UE, wherein the measurement report and the derived measurement report are generated by the first UE according to the measurement.

13. The method of claim 12, wherein the configuration message indicates at least one of a reference signal for the measurement and an uplink resource allocated for transmitting the measurement report message.

14. The method of claim 12, wherein the confirming of the measurement association further comprises:
receiving, by the processor, an association confirmation message from the first UE, wherein the association confirmation message indicates that the first UE is capable of generating the derived measurement report of the second UE.

15. The method of claim 12, wherein the confirming of the measurement association further comprises:
determining, the processor, whether a similarity of the communication quantity between the first UE and the second UE is greater than a threshold based on a plurality of first measurement report messages generated by the first UE and a plurality of second measurement report messages generated by the second UE;
confirming, by the processor, the measurement association in an event that the similarity is greater than the threshold; and
transmitting, by a processor, an association confirmation message to the first UE or the second UE for the measurement association between the first UE and the second UE for the communication quantity.

16. The method of claim 12, further comprising:
receiving, by the processor, a termination message from the first UE indicating that the first UE terminates the measurement association with the second UE.

17. The method of claim 12, further comprising:
transmitting, by the processor, a termination message to the first UE.

18. The method of claim 12, wherein the communication quantity is for one of the following purposes: CSI computation, BM report calculation, UE Rx/Tx beam sweeping, RRM measurement, and mobility measurement.

19. A method, comprising:
generating, by a processor of an apparatus, a measurement association with a UE for a communication quantity;
receiving, by the processor, a derived measurement report from the UE, wherein the derived measurement report is generated by the UE after performing a measurement for the communication quantity with respect to a network node; and
transmitting, by the processor, a measurement report message according to the derived measurement report to the network node.

20. The method of claim 19, wherein the measurement report message includes the derived measurement report or a refined measurement report to the network node, and wherein the refined measurement report is generated according to the derived measurement report.
